(19) United States
(12) Patent Application Publication
(10) Pub. No.: US 2010/0250613 A1
(43) Pub. Date: Sep. 30, 2010

(54) QUERY PROCESSING USING ARRAYS

(75) Inventors: Igor Ostrovsky, Bellevue, WA (US); John Duffy, Renton, WA (US); Stephen H. Toub, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/413,814

(22) Filed: Mar. 30, 2009

(51) Int. Cl. G06F 17/30

(52) U.S. Cl. 707/801; 707/E17.014

(57) ABSTRACT

A method of processing a query includes receiving a language integrated query including at least one operator, and operating on an input array with the at least one operator. An output array is generated by the at least one operator based on the operation on the input array.

### BACKGROUND

A developer may construct a query using a predefined query language. The developer then typically uses a compiler tool to translate the query into code that calls appropriate library functions to execute the query. One type of query is a language integrated query, which is typically based on lazy data sequences. As one example, Microsoft® provides a LINQ to Objects library, which provides a variety of query operators to transform lazy sequences through the application of filters, projections, joins, reductions, and other bulk data operations. A user can write queries against any input sequence that implements an IEnumerable<T> interface. A typical language integrated query operator accepts one or more input sequences, and returns an output sequence. An enumerator is used to sequentially “walk” through the sequences. Some sequences provide more efficient access methods such as a mechanism to retrieve an element at a specific ordinal index.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Language integrated queries are typically used to provide abstractions over various kinds of sequence-based operations. Language integrated queries are typically based on lazy sequences, as opposed to lazy arrays. One embodiment provides a language integrated query library that is based on lazy arrays, and provides selective index-based access to array elements.

In one embodiment, a language integrated query including at least one operator is received. An input array is operated on by the at least one operator. An output array is generated by the at least one operator based on the operation on the input array.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a diagram illustrating a computing system suitable for performing array-based query processing according to one embodiment.

FIG. 2 is a diagrammatic view of an array-based query processing application for operation on the computer system illustrated in FIG. 1 according to one embodiment.

FIG. 3 is a flow diagram illustrating a method of processing a query according to one embodiment.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

One embodiment provides an array-based query processing application, but the technologies and techniques described herein also serve other purposes in addition to these. In one implementation, one or more of the techniques described herein can be implemented as features within a framework program such as Microsoft® .NET Framework, or within any other type of program or service.

Language integrated queries are typically used to provide abstractions over various kinds of sequence-based operations. A language integrated query according to one embodiment is a query that is an integrated feature of a developer's primary programming language (e.g., C#, Visual Basic). Language integrated queries according to one embodiment allow query expressions to benefit from rich metadata, compile-time syntax checking, and static typing that was previously available only to program code written in a statically type-checked language, and specifically not queries that are customarily embedded into such programs as untyped strings. As an example, Microsoft® supports the LINQ (Language Integrated Query) programming model, which is a set of patterns and technologies that allow the user to describe a query that will execute on a variety of different execution engines. LINQ provides .NET developers with the ability to query and transform data sequences using any of a variety of .NET programming languages.

In one embodiment, a developer describes a query using a convenient query syntax that consists of a variety of query operators such as projections, filters, aggregations, and so forth. The operators themselves may contain one or more expressions or expression parameters. For example, a “Where” operator will contain a filter expression that will determine which elements should pass the filter. An expression according to one embodiment is a combination of letters, numbers, and symbols used to represent a computation that produces a value. The operators together with the expressions provide a complete description of the query.

Language integrated queries are typically based on lazy sequences and do not offer the ability to access intermediate or final results as indexible arrays. A typical query operator in these systems accepts one or more input sequences, and returns an output sequence. One embodiment provides a language-integrated query library that is based on lazy arrays. A lazy array according to one embodiment is an array in which the elements of the array are computed on-demand (as opposed to “eagerly”), and all elements of the array need not be evaluated when the array is evaluated (i.e., the elements of the array can be selectively accessed by indices and evaluated). For example, in one embodiment, when an element of a lazy array is first accessed, the element is computed at that time; and if the element is accessed again later, the element is recomputed at that time. In one embodiment, elements that have already been computed may be stored in memory to avoid re-computing these elements. The array-based query library according to one embodiment has advantages over a sequence-based query library. For example, some operators can be implemented much more efficiently, and the user can directly index into the results of the query, rather than only iterating through the sequence with an enumerator. Another embodiment provides a hybrid sequence/array query library that combines advantages of the sequence-based and array-based query libraries.

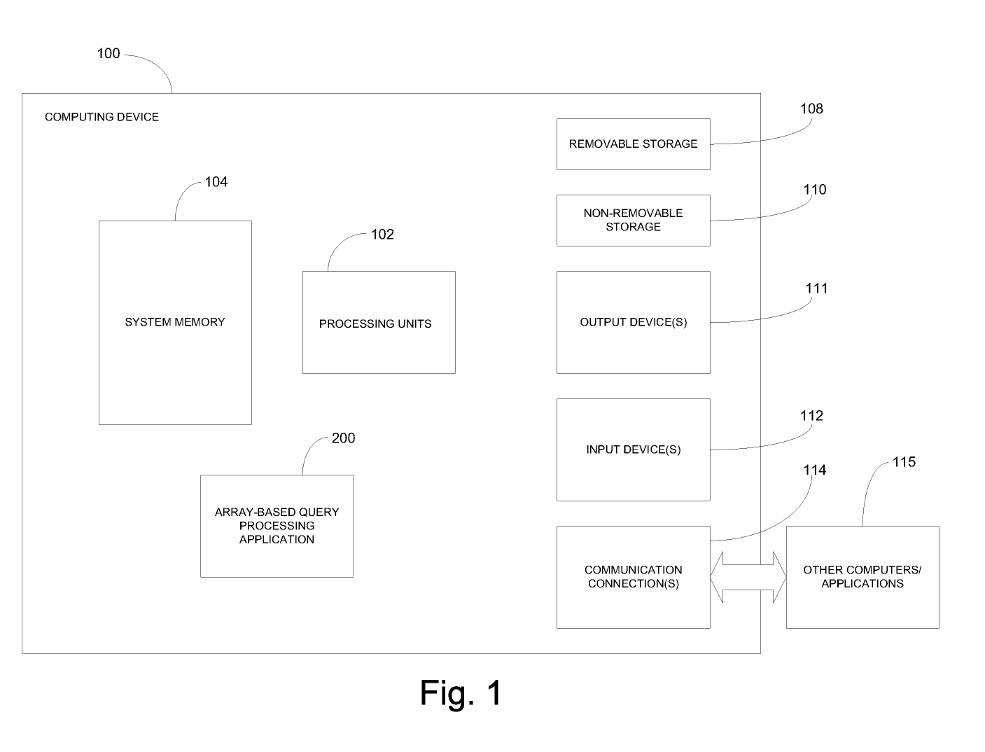

FIG. 1 is a diagram illustrating a computing device 100 suitable for performing array-based query processing according to one embodiment. In the illustrated embodiment, the computing system or computing device 100 includes a plurality of processing units 102 and system memory 104. Depending on the exact configuration and type of computing device, memory 104 may be volatile (such as RAM), non-volatile (such as ROM, flash memory, etc.), or some combination of the two.

Computing device 100 may also have additional features/functionality. For example, computing device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media (e.g., computer-readable storage media storing computer-executable instructions for performing a method). Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by computing device 100. Any such computer storage media may be part of computing device 100.

Computing device 100 includes one or more communication connections 114 that allow computing device 100 to communicate with other computers/applications 115. Computing device 100 may also include input device(s) 112, such as keyboard, pointing device (e.g., mouse), pen, voice input device, touch input device, etc. Computing device 100 may also include output device(s) 111, such as a display, speakers, printer, etc.

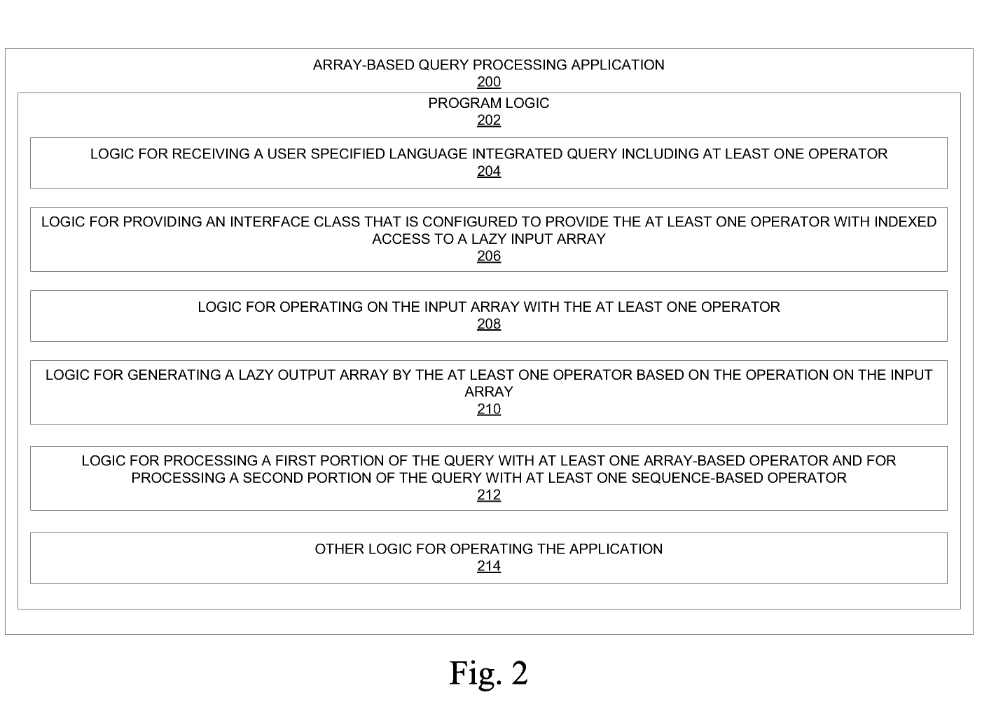

In one embodiment, computing device 100 includes an array-based query processing application 200 for performing processing of queries using lazy arrays. Query processing application 200 is described in further detail below with reference to FIG. 2.

FIG. 2 is a diagrammatic view of an array-based query processing application 200 for operation on the computing device 100 illustrated in FIG. 1 according to one embodiment. Application 200 is one of the application programs that reside on computing device 100. However, application 200 can alternatively or additionally be embodied as computer-executable instructions on one or more computers and/or in different variations than illustrated in FIG. 1. Alternatively or additionally, one or more parts of application 200 can be part of system memory 104, on other computers and/or applications 115, or other such suitable variations as would occur to one in the computer software art.

Array-based query processing application 200 includes program logic 202, which is responsible for carrying out some or all of the techniques described herein. Program logic 202 includes logic 204 for receiving a user specified language integrated query including at least one operator; logic 206 for providing an interface class that is configured to provide the at least one operator with indexed access to a lazy input array; logic 208 for operating on the input array with the at least one operator; logic 210 for generating a lazy output array by the at least one operator based on the operation on the input array; logic 212 for processing a first portion of the query with at least one array-based operator and for processing a second portion of the query with at least one sequence-based operator; and other logic 214 for operating the application.

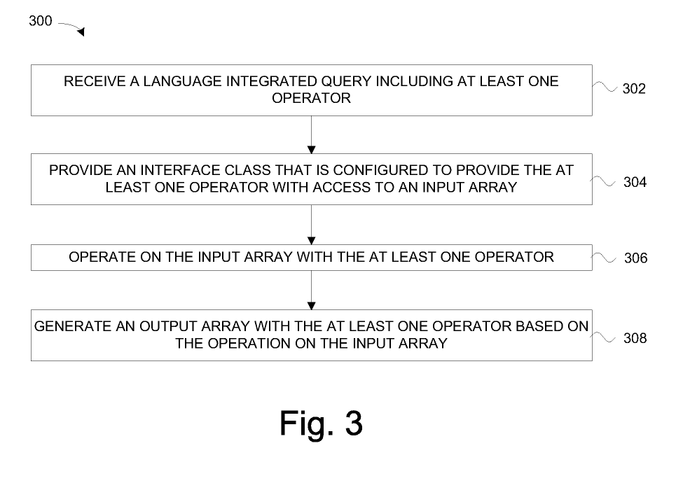

Turning now to FIG. 3, techniques for implementing one or more embodiments of array-based query processing application 200 are described in further detail. In some implementations, the techniques illustrated in FIG. 3 are at least partially implemented in the operating logic of computing device 100.

FIG. 3 is a flow diagram illustrating a method 300 of processing a query according to one embodiment. At 302 in method 300, a language integrated query including at least one operator is received. In one embodiment, the query is specified in a high-level programming language (e.g., C# or Visual Basic). At 304, an interface class is provided that is configured to provide the at least one operator with access to an input array. In one embodiment, the interface class includes a first method for providing indexed access to elements in the input array, and a second method for obtaining a count value representing a total number of elements in the input array. At 306, the input array is operated on by the at least one operator. At 308, an output array is generated by the at least one operator based on the operation on the input array. In one embodiment, the input array and the output array in method 300 are each a lazy array.

The query received at 302 according to one embodiment includes a plurality of operators, with each operator configured to receive a lazy array as an input and generate a lazy array as an output. In one embodiment, the query received at 302 comprises at least one of the following operators: a select operator configured to perform a projection on each element in the input array and return a lazy array based on the projection; a take operator configured to take a specified number of elements from the input array and return a lazy array containing only the taken elements; a skip operator configured to skip a specified number of elements in the input array and return a lazy array containing elements positioned after the skipped elements; a reverse operator configured to reverse positions of elements in the input array and return a lazy array containing elements with the reversed positions; a concatenate operator configured to concatenate the input array with a second input array and return a lazy array comprising a concatenation of the input arrays; a zip operator configured to combine the input array with a second input array using a pairwise function and return a lazy array representing the combination; and an operator configured to evaluate all elements in the input array.

The following Table I provides a summary of query operators that may be included in the received query of method 300 according to one embodiment:

TABLE I

| Operator | Operation |
|---|---|
| Select(func) | Projects each element using the func projection |
| | function. So, given a lazy array {a₁, a₂, . . . aₙ} |
| | returns a lazy array {func(a₁), func(a₂), . . . |
| | func(aₙ)}. |
| Take(N) | Takes the first N elements from the lazy array. So, if |
| | we apply Take(3) to {1, 2, 3, 4, 5}, we get |
| | {1, 2, 3}. |
| Skip(N) | Skips the first N elements in the lazy array. |
| Reverse | Reverses the lazy array. |
| Concat(ILazyArray) | Concatenates two lazy arrays. |
| Zip(ILazyArray, | Combines two lazy arrays using a pairwise function. |
| func) | Given arrays {a₁, a₂, . . . aₙ} and {b₁, b₂, . . . bₙ}, |
| | returns a lazy array {func(a₁, b₁), func(a₂, b₂), . . . |
| | func(aₙ, bₙ)}. |
| ToArray | Evaluates all elements in the lazy array |

It will be understood that additional or different operators than those listed in Table I may be used in method 300, and that Table I is not meant to be limiting.

As mentioned above, at 304 in method 300, an interface class is provided that is configured to provide the at least one operator with access to an input array. In one embodiment, the interface class provided at 304 is implemented as shown in the following Pseudo Code Example I:

### Pseudo Code Example I

```
public interface ILazyArray <T> {
    int GetCount( );
    T GetElement(int index);
}
```

In one embodiment, the query operators in method 300 are lazy transforms of the ILazyArray<T> class given in Pseudo Code Example I, and the operators input and output IArray<T> types. As an example, consider a Skip(N) operator, where N is an integer. The Skip(N) operator drops the first N elements in the input array and returns an output array with the remaining elements. For example, assume that a Skip(3) operator is applied to the input array {1,2,3,4,5,6}, as shown in the following Pseudo Code Example II:

### Pseudo Code Example II

int[ ] arr = new int[ ] { 1,2,3,4,5,6 };
ILazyArray<int> res = arr.AsLazyArray( ).Skip(3);

The result of the Skip(3) operator being applied to the input array {1,2,3,4,5,6} as shown in the above Example II is the lazy output array {4,5,6}. AsLazyArray( ) in Example II is a C# extension method that wraps a regular C# array with a class that implements the methods specified by the ILazyArray( ) interface. Skip(N) according to one embodiment is also an extension method that accepts an ILazyArray<T> input and returns a LazyArray<T> output, where the output array is similar to the input array, except that it does not include the first N elements.

Method 300 will now be described in further detail with reference to the example query given in the following Pseudo Code Example III:

### Pseudo Code Example III

```
int[ ] arr = new int[ ] { 1,2,3,4,5,6 };
ILazyArray<int> res =
arr.AsLazyArray( )
  .Reverse( );
  .Skip(3)
  .Select(x => −x)
```

In Example III, the array, res, is a lazy array that represents a computation including several of the operators described above. In this example, three elements of the array, arr, are skipped, and three of the elements, at most, are taken, negated and their order is reversed. The Select operator is typically found at the bottom of a language integrated query and determines what the query will return when executed. In one embodiment, the computation in Example III only occurs when the elements of the array, res, are accessed. For example, assuming that a user tried to access the second element (e.g., the element with an index value of 1) of the array, res, the query in Example III would behave as follows according to one embodiment:

```
1. SelectArray.GetElement(1) called
    2. SkipArray.GetElement(1) called
        3. ReverseElement.GetElement(4) called
            4. LazyArray.GetElement(1) called
            5. LazyArray returns arr[1], which equals 2
        6. ReverseElement.GetElement returns 2
    7. SkipArray.GetElement returns 2
8. SelectArray.GetElement(1) returns −2
```

In the above example, SelectArray.GetElement(1) calls SkipArray.GetElement(1), which calls ReverseElement.GetElement(4). As shown in Pseudo Code Example III, the Skip operator has an argument (or index) of “3”, so the indices are effectively shifted by three and the Skip operator, therefore, calls ReverseElement.GetElement with an argument of “4” (corresponding to the fifth element). The Reverse operator knows the total number of elements in the input array (i.e., six), and in order to get the fifth element (i.e., an element with an index of “4”) in the reversed sequence, Reverse calls LazyArray.GetElement with an argument of “1” (i.e., 6−5=1). LazyArray then returns arr[1], which is the second element in the reversed array and which has a value of “2”. ReverseElement.GetElement and SkipArray.GetElement also return “2”. SelectArray.GetElement applies the transformation (i.e., x=>−x) to the element, thereby negating the element, and returns the negated element (i.e., “−2”). Thus, the second element of the array, res, is “−2”. In one embodiment, this particular element is computed on demand, without computing any of the other elements in the array, res. The array, res, is therefore a lazy array since its elements are not computed ahead of time, but instead one-by-one, as they are accessed.

There are several advantages of the array-based queries set forth herein over sequence-based queries. One advantage is that some operators can be implemented more efficiently on array-based queries than on sequence-based queries. For example, the Reverse operator is efficient on array-based queries (e.g., the elements are efficiently remapped to different indices). However, on sequence-based queries, the Reverse operator typically accumulates the entire sequence into an auxiliary data structure in order to reverse it, which is a more costly operation. Another advantage provided by embodiments of the array-based queries disclosed herein is that the user immediately knows how many elements the output of the query will contain. If the user wishes to capture the output of the query into an array, a correctly-sized array can be quickly created, instead of having to use a more costly dynamically-grown data structure. Also, the elements of the output array can be selectively accessed at chosen positions.

Some implementations of array-based queries may not support all operators that sequence-based queries do, such as a filtering operator (e.g., filter out all odd integers). One embodiment solves this issue by providing a hybrid sequence/array query library. By treating an array as a sequence (e.g., by accessing the elements in the order of the indices), sequence operators can be applied to arrays. For example, once a filtering operator is applied to a lazy array, the result according to one embodiment is a lazy sequence. Other operators that transform lazy sequences can continue to be applied. In this manner, the efficiency of lazy arrays is provided for at least part of a query, and the number of supported query operators is increased.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of processing a query, comprising:
receiving a language integrated query including at least one operator;
operating on an input array with the at least one operator; and
generating an output array with the at least one operator based on the operation on the input array.

2. The method of claim 1, wherein the input array and the output array are each a lazy array.

3. The method of claim 1, and further comprising:
providing an interface class configured to provide the at least one operator with access to the input array.

4. The method of claim 3, wherein the interface class includes a first method for providing indexed access to elements in the input array.

5. The method of claim 4, wherein the interface class includes a second method for obtaining a count value representing a total number of elements in the input array.

6. The method of claim 1, wherein the query includes a plurality of operators, and wherein each operator is configured to receive a lazy array as an input and generate a lazy array as an output.

7. The method of claim 1, wherein the query is specified in a high-level programming language.

8. The method of claim 7, wherein the high-level programming language is C# or Visual Basic.

9. The method of claim 1, wherein the at least one operator comprises a select operator configured to perform a projection on each element in the input array and return a lazy array based on the projection.

10. The method of claim 1, wherein the at least one operator comprises a take operator configured to take a specified number of elements from the input array and return a lazy array containing only the taken elements.

11. The method of claim 1, wherein the at least one operator comprises a skip operator configured to skip a specified number of elements in the input array and return a lazy array containing elements positioned after the skipped elements.

12. The method of claim 1, wherein the at least one operator comprises a reverse operator configured to reverse positions of elements in the input array and return a lazy array containing elements with the reversed positions.

13. The method of claim 1, wherein the at least one operator comprises a concatenate operator configured to concatenate the input array with a second input array and return a lazy array comprising a concatenation of the input arrays.

14. The method of claim 1, wherein the at least one operator comprises an operator configured to combine the input array with a second input array using a pairwise function and return a lazy array representing the combination.

15. The method of claim 1, wherein the at least one operator comprises an operator configured to evaluate all elements in the input array.

16. The method of claim 1, and further comprising:
processing a first portion of the query with at least one array-based operator and processing a second portion of the query with at least one sequence-based operator.

17. A computer-readable storage medium storing computer-executable instructions for performing a method, comprising:
receiving a language integrated query including at least one operator;
operating on a lazy input array with the at least one operator;
generating a lazy output array with the at least one operator based on the operation on the input array.

18. The computer-readable storage medium of claim 17, wherein the method further comprises:
providing an interface class configured to provide the at least one operator with access to the input array, wherein the interface class includes a first method for providing indexed access to elements in the input array.

19. The computer-readable storage medium of claim 18, wherein the interface class includes a second method for obtaining a count value representing a total number of elements in the input array.

20. A method of processing a query, comprising:
receiving a language integrated query including at least one operator;
providing an interface class configured to provide the at least one operator with access to an input array, wherein the interface class includes a first method for providing indexed access to elements in the input array, and wherein the interface class includes a second method for obtaining a count value representing a total number of elements in the input array;
operating on the input array with the at least one operator; and
generating an output array with the at least one operator based on the operation on the input array.
